(19) United States
(12) Patent Application Publication
(10) Pub. No.: US 2018/0202448 A1
(43) Pub. Date: Jul. 19, 2018

(54) LOW NOISE FAN ROTATIONAL SPEED CONTROL DEVICE

(71) Applicant: EVGA CORPORATION, New Taipei City (TW)

(72) Inventor: Tai-Sheng Han, New Taipei City (TW)

(21) Appl. No.: 15/458,027

(22) Filed: Mar. 14, 2017

(30) Foreign Application Priority Data
Jan. 16, 2017 (TW) 106200780

(51) Int. Cl. F04D 27/00; F04D 29/66; G05B 19/416; G05D 23/19; G06F 1/20

(52) U.S. Cl. CPC F04D 27/004; F04D 29/663; G05B 2219/37347; G05D 23/1917; G06F 1/206; G05B 19/416

(57) ABSTRACT

A low noise fan rotational speed control device includes a graphics card body, at least one temperature detector that detects an environment temperature and generate a first temperature information, at least one heat dissipation device, a control device, a computation unit that sets up a second temperature information, and a rotational speed database, which compares temperature difference information between the first temperature information and the second temperature information to retrieve rotational speed information to allow the control device to adjust a minimum rotational speed of the heat dissipation device. With the above structure, a temperature difference between a set temperature and a measured temperature is calculated and rotational speed information that corresponds to the temperature difference information is read from a rotational speed database in order to set up a fan activation mechanism of minimum power consumption, making the measured temperature approach the set temperature as close as possible.

### TECHNICAL FIELD OF THE INVENTION

The present invention relates generally to a low noise fan rotational speed control device, and more particularly to a low noise fan rotational speed control device that controls, in a limited manner, a fan to rotate at a lowest rotational speed to dissipate heat from a graphics card and maintain the graphics card operating at a temperature below a preset level so as to reduce noise generated by the fan.

### DESCRIPTION OF THE PRIOR ART

Most of the graphics cards are provided with an independent graphic processing unit (GPU) chip. Due to an extremely high amount of computation in the GPU, the amount of heat generated is also very high and may indirectly cause a continuous increase of the temperature inside a computer. To avoid such a problem, the GPUs of most of the graphics cards are provided heat dissipation fans for dedicated use therewith to dissipate heat. A common solution that is adopted in the industry is to control the rotational speed of the fan according to the temperature of the GPU. When an excessively high temperature of the GPU is detected, the rotational speed of the fan corresponding thereto is increased to improve the efficiency of heat dissipation for lowering down the temperature of the GPU in order to maintain a normal operation of the graphics card.

However, when the rotational speed of the heat dissipation fan is increased, the noise generated by the heat dissipation fan is also increased, leading to undesired operation trouble of the user. Although each of the graphics card manufacturers provides specification concerning a ratio between the noise level and the rotational speed for the heat dissipation fan, such as 2000 RPM/27 dB and 3500 RPM/37 dB, in order to prevent the heat dissipation fan from rotating excessively fast and thus generating an excessively high level of noise, it is still a concern of a user of being troubled by the noise.

To make the noise volume generated during the operation of a heat dissipation fan fit to the requirement of a user is an issue that the graphics card manufacturers must dissolve. However, the prior art techniques in control the noise of a heat dissipation fan of a graphics card suffers the following problems that must be further improved:

(1) Unlimitedly increasing the rotational speed of a fan, although improving the heat dissipation performance, heightens decibel of the noise.

(2) Unlimitedly constraining the rotational speed of a fan, although lowering down the noise level, sacrifices the performance of heat dissipation.

(3) Using multiple fans or unique designs of fan to help dissipate heat increases the cost of fan.

(4) Activating a fan or increasing a rotational speed of the fan at the time of overheating and deactivating the fan or lowering the rotational speed of the fan at the time of low temperature would unnecessarily increase the power consumption of the fan to switch between activating and deactivating and would make it hard or impossible to stably control the rotational speed of the fan.

Thus, it is a challenge of those devoted in this field to provide a solution to overcome such problems.

### SUMMARY OF THE INVENTION

In view of the above problems and drawbacks, the present invention aims to provide a low noise fan rotational speed control device that controls, in a limited manner, a fan to rotate at a lowest rotational speed to dissipate heat from a graphics card and maintain the graphics card operating at a temperature below a preset level so as to reduce noise generated by the fan.

The primary objective of the present invention is to set up a fan activation mechanism of minimum power consumption according to detection information in order to start up one or multiple fans to achieve optimum balance between heat dissipation and low noise.

Another objective of the present invention is to retrieve a most-fit rotational speed value according to a temperature difference between a set temperature and a measured temperature.

To achieve the above objective, the present invention comprises, structurally, a graphics card body, wherein the graphics card body is provided thereon with at least one temperature detector for detecting an environment temperature to generate first temperature information, at least one heat dissipation device arranged on the graphics card body and located at one side of the temperature detector, a control device arranged on the graphics card body and eclectically connected with the temperature detector and the heat dissipation device, a computation unit arranged in the control device for setting up second temperature information to generate temperature difference information according to the first temperature information and the second temperature information, wherein the control device is set in electrical connection with a rotational speed database for comparing the temperature difference information to retrieve rotational speed information that allows the control device to adjust a minimum rotational speed of the heat dissipation device. To use the graphics card body according to the present invention, the computation unit is first operated to set the second temperature information, which serves as a predetermined critical value of heat source temperature, and the temperature detector transmits an actual temperature (the first temperature information) detected thereby to the computation unit to generate the temperature difference information, so that with reference to data loaded in the rotational speed database, the control device may control the heat dissipation device according to the rotational speed information. As such, the heat dissipation device can be controlled to stably operate at minimum power consumption with an actual temperature thereof approaching a set temperature so as to suppress decibel of noise while ensuring no overheating of the graphics card body.

With the above technique, the problems and drawbacks of a prior art graphics card heat dissipation fan that optimum balance between the rotational speed of the fan and the noise generated by the operation thereof cannot be achieved, the rotational speed of the fan is unstable, and the cost is high can be overcome and advantages of utilization mentioned above can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is an exploded view of the preferred embodiment of the present invention.

FIG. 3 is a structure block diagram of the preferred embodiment of the present invention.

FIG. 4 is a plot illustrating a rotational speed curve of the preferred embodiment of the present invention.

FIG. 5 is a plot view illustrating a temperature curve of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

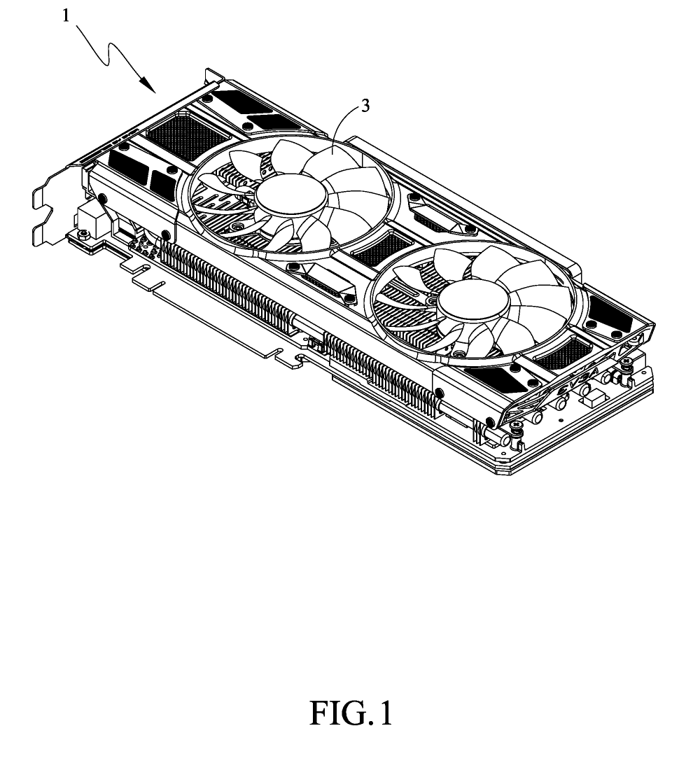

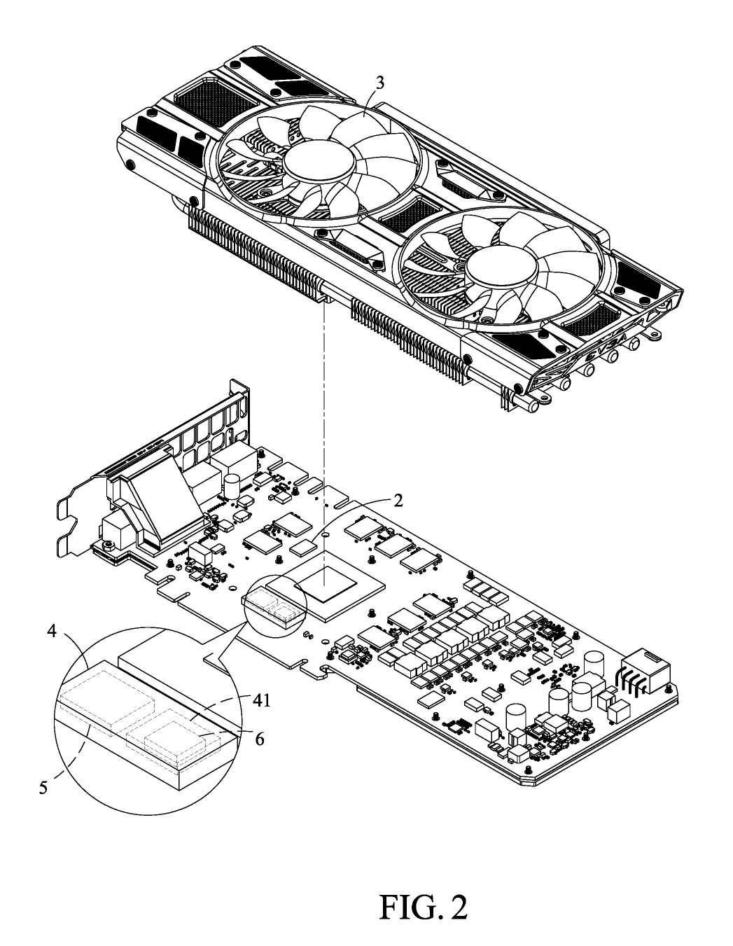

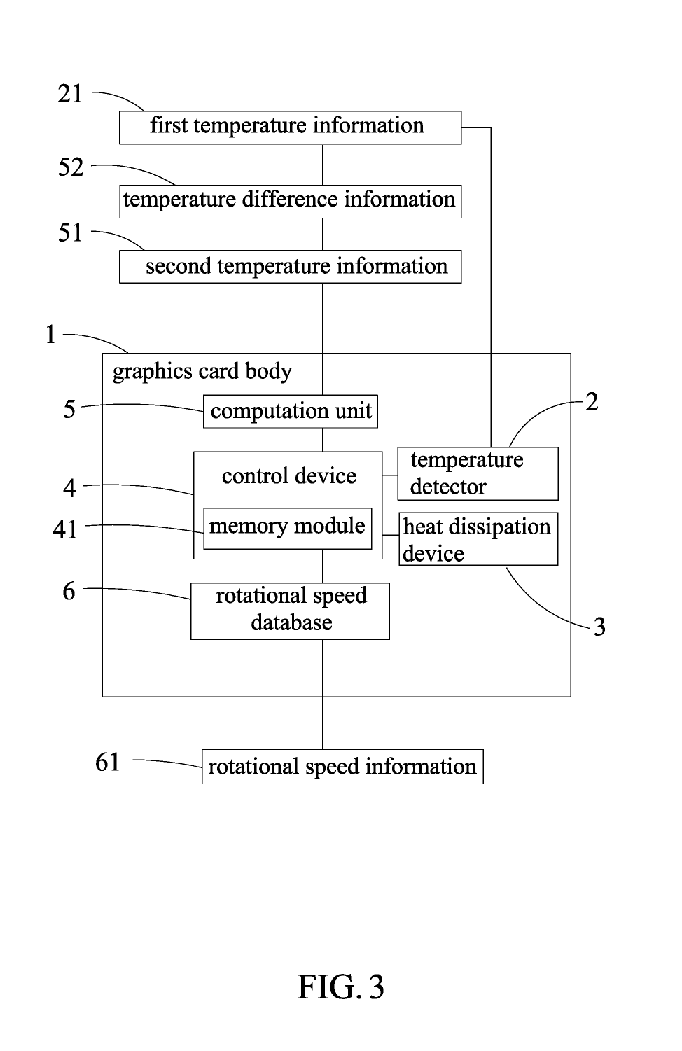

Referring to FIGS. 1-3, which are respectively a perspective view showing a preferred embodiment of the present invention, an exploded view of the preferred embodiment of the present invention, and a structure block diagram of the preferred embodiment of the present invention, it can be clearly seen from the drawings that the present invention comprises:

a graphics card body 1;

at least one temperature detector 2 arranged on the graphics card body 1 for detecting an environment temperature to generate first temperature information 21;

at least one heat dissipation device 3 arranged on the graphics card body 1 and located at one side of the temperature detector 2;

a control device 4 arranged on the graphics card body 1, the control device 4 being electrically connected to the temperature detector 2 and the heat dissipation device 3, the control device 4 comprising a micro controller unit (MCU) or control software, the control device 4 comprising a memory module 41 for storage of a temperature difference-rotational speed table for a rotational speed database 6 that will be described hereinafter;

a computation unit 5 arranged on the control device 4 for setting up second temperature information 51 and generating temperature difference information 52 according to the first temperature information 21 and the second temperature information 51; and

a rotational speed database 6 in electrical connection with the control device 4 for comparison with the temperature difference information 52 to retrieve rotational speed information 61 to allow the control device 4 to adjust a minimum rotational speed of the heat dissipation device 3, wherein the rotational speed information 61 comprises a rotational speed curve that varies with time.

The structure according to the present invention can be appreciated from the above description, and it is possible to conduct an operation in combination with and corresponding to such a structure for controlling, in a limited manner, a fan to operate at the minimum rotational speed for dissipating heat from a graphics card, in order to achieve advantages of maintaining the graphics card to operate at a temperature below a preset level and reducing the noise of the fan. Details will be provided below.

Referring collectively to FIGS. 1-5, which are respectively a perspective view showing a preferred embodiment of the present invention, an exploded view of the preferred embodiment of the present invention, a structure block diagram of the preferred embodiment of the present invention, a plot illustrating a rotational speed curve of the preferred embodiment of the present invention, and a plot view illustrating a temperature curve of the preferred embodiment of the present invention, based on the structural components provided above, it can be clearly seen from the drawings that structurally, the present invention uses various components/parts, including the control device 4, the computation unit 5, and the rotational speed database 6, to set up a fan activation mechanism of minimum power consumption based on temperature difference so as to make the temperature of the graphics card body 1 approaching but not exceeding a critical temperature (the second temperature information 51) set by a user in order to achieve the above-discussed advantages.

In a practical operation, the user uses the computation unit 5 of the control device 4 to set up the second temperature information 51 to serve as a predetermined critical level of heat source temperature under which the graphics card body 1 may operate normally. Then, the graphics card body 1, during an operation thereof, uses the temperature detector 2 to detect an environment temperature and generate first temperature information 21, and transmits the first temperature information 21 to the computation unit 5 of the control device 4 to allow the computation unit 5 to compute a temperature difference between the first temperature information 21 and the second temperature information 51 and generate temperature difference information 52, and then, the control device 4 establishes, through the memory module 41, connection with the temperature difference-rotational speed table of the rotational speed database 6 and retrieves rotational speed information 61 according to the temperature difference information 52 to allow the control device 4 to control the heat dissipation device 3 with the rotational speed information 61 that satisfies minimum power consumption requirement.

The rotational speed information 61 comprises a rotational speed curve that is obtained through tests and experiments, where the rotational speed varies with time and the rotational speed is a parameter that is directly related to the second temperature information 51 so that under a condition that the graphics card body 1 continuously generates heat in a generally unstopped manner, the heat dissipation device 3 may maintain operation at such a rotational speed to make the temperature of the graphics card body 1 approaching [symbol] the second temperature information 51. In other words, the control device 4 controls the rotational speed of the heat dissipation device 3 in such a way as to reduce a temperature difference from the temperature difference information 52, or even to make the temperature difference approach zero to allow the graphics card body 1 to maintain at the predetermined critical level of heat source preset by the user (namely the second temperature information 51).

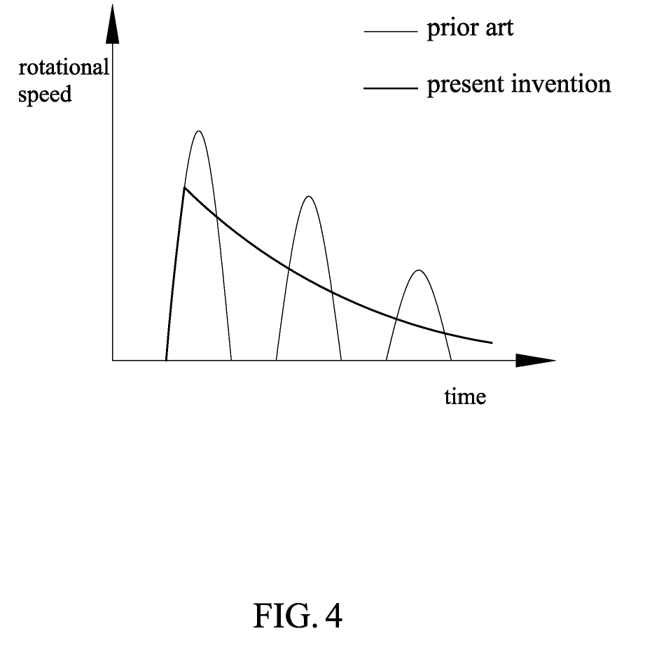

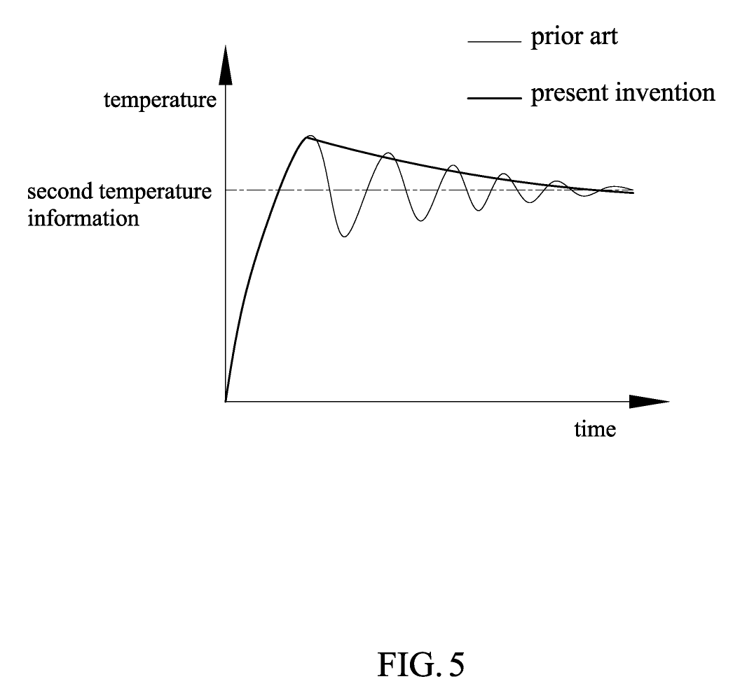

Further, comparison of the heat dissipation device 3 according to the present invention with a prior art fan in respect of the rotational speed (FIG. 4 showing curves of the present invention and prior art), under the condition of rotational speed set previously, the heat dissipation device 3 according to the present invention, although not operated at a high speed to fast lower down the temperature of the graphics card body 1, is operated along a most efficient rotational speed curve associated with the minimum rotational speed and/or he minimum noise (where the heat dissipation device 3 is activated when the first temperature information 21 gets greater than a predetermined value and the temperature difference is gradually lowered down with the extension or lapse of the time period of heat dissipation operation, and the rotational speed is gradually reduced at the same time) so as stably reduce the temperature of the graphics card body 1 (as indicated by the curve of FIG. 5 representing the present invention). On the other hand, the operation mode of the prior art temperature-detecting heat dissipation fan is such that a high speed operation is activated whenever a condition of excessively high temperature is detected and the operation is shut down after temperature drops, so that the rotational speed of the fan may repeatedly switch between high and low speeds (as indicated by the curve of FIG. 4 representing the prior art); this leads to high degree of fluctuation of temperature variation and each time when the fan re-started from a standstill condition, a great noise may be generated (as indicated by the curve of FIG. 5 representing the prior art). Thus, the present invention allows a user to reduce the rotational speed of the heat dissipation device 3 to the minimum under a condition where the temperature of the graphics card body 1 does not exceed a preset temperature level (the second temperature information 51) so as to achieve the purpose of reducing the noise of the fan.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A low noise fan rotational speed control device, comprising:
a graphics card body;
at least one temperature detector arranged on the graphics card body for detecting an environment temperature to generate first temperature information;
at least one heat dissipation device arranged on the graphics card body and located at one side of the temperature detector;
a control device arranged on the graphics card body, such that the control device is electrically connected with the temperature detector and the heat dissipation device;
a computation unit arranged in the control device for setting a second temperature information and generating temperature difference information according to the first temperature information and the second temperature information; and
a rotational speed database in electrical connection with the control device for comparing the temperature difference information and retrieving rotational speed information to allow the control device to adjust a minimum rotational speed of the heat dissipation device.

2. The low noise fan rotational speed control device according to claim 1, wherein the control device comprises a memory module for storage of a temperature difference-rotational speed table of the rotational speed database.

3. The low noise fan rotational speed control device according to claim 1, wherein the rotational speed information comprises a curve of rotational speed varying with time.

4. The low noise fan rotational speed control device according to claim 1, wherein the control device controls a rotational speed of the heat dissipation device such that a temperature difference value of the temperature difference information is reduced.

5. The low noise fan rotational speed control device according to claim 4, wherein temperature difference value approaches zero.

6. The low noise fan rotational speed control device according to claim 1, wherein the control device comprises a micro controller unit (MCU).

7. The low noise fan rotational speed control device according to claim 1, wherein the control device comprises control software.
